(19) United States
(12) Patent Application Publication
(10) Pub. No.: US 2020/0055231 A1
(43) Pub. Date: Feb. 20, 2020

(54) APPARATUS AND METHOD FOR PRODUCING SEALING RINGS, ALSO A CONTROL DEVICE AND USE THEREOF FOR THIS PURPOSE, USE OF A ROTATABLY MOUNTED DISC FOR THIS PURPOSE, AND A SEALING RING

(71) Applicant: GLUESEAL INNOVATION GMBH, ESSEN (DE)

(72) Inventor: TIM CHYLA, ESSEN (DE)

(73) Assignee: GLUESEAL INNOVATION GMBH, ESSEN (DE)

(21) Appl. No.: 16/333,233

(22) PCT Filed: Sep. 14, 2017
(86) PCT No.: PCT/DE2017/100776

§ 371 Date: Apr. 30, 2019

(30) Foreign Application Priority Data
Sep. 17, 2016 (DE) 10 2016 117 544.7

(51) Int. Cl. B29C 53/36; B29C 65/52

(52) U.S. Cl. CPC B29C 53/36; B29C 65/7451; B29C 65/524

(57) ABSTRACT

A device for producing sealing rings made of an endless-material. The device includes a feeder unit which conveys and positions the endless-material in a cutting position, a cutting unit which cuts off a section of the endless-material, a gripper unit which grips and displaces the endless-material or the section of the endless-material and which controls a displacement of at least one free end of the section of the endless-material along a predefined path of motion in and/or out of a wetting position, a control device connected with the feeder unit, the at least one gripper unit and/or the cutting unit, and a feeding device for a bonding fluid. The feeding device is connected with the control device and is arranged so that the bonding fluid is deposited in a controlled manner on the at least one free end of the section of the endless material in the wetting position.

### CROSS REFERENCE TO PRIOR APPLICATIONS

This application is a U.S. National Phase application under 35 U.S.C. § 371 of International Application No. PCT/DE2017/100776, filed on Sep. 14, 2017 and which claims benefit to German Patent Application No. 10 2016 117 544.7, filed on Sep. 17, 2016. The International Application was published in German on Mar. 22, 2018 as WO 2018/050164 A1 under PCT Article 21(2).

### FIELD

The present invention refers to a device for production of elastic, flexible sealing rings, for example O-rings made of elastomer material (e.g. cellular rubber) or specific plastic material, e.g. high-temperature resistant plastic material. Further, a corresponding method is referred to, especially in view of preferably high degree of automation. Not least, the invention also refers to the use elucidated in the claims.

### BACKGROUND

Sealing rings are used in nearly every technical field, be it for sealing against fluids, acoustic noise, emissions, vibrations, etc. One of the endless applications refers to chemical vessels which require to seal a closure head. Same as the fields of applications, there are diversified materials which can be used. Rubber rings or O-rings may e.g. be made of cords by cutting the cords in desired lengths and then by providing adhesive bond. The use of cords, e.g. EPDM-, VMQ (methyl vinyl silicone)-, and FKM-cords may provide for a static seal e.g. for the sealing of relatively big pipe connections and for a lid gasket in container constructions. Due to great lot sizes required in many situations there is a need for a preferably high degree of automation for the production of the sealing rings. In particular, positive substance jointing still has to be done manually for multiple materials or applications. Cords are used in many situations directly at the site of operation, e.g. for maintenance and repair, and they are joint “to size” in order to provide a ring. Therefore, e.g., cyanoacrylate or two-component adhesive can be used.

The following publications describe devices and methods in this regard: DE 37 39 058 A1, EP 0 567 502 B1, DE 35 32 440 A1, DE 25 47 128 C2, DE 2 056 460 A, DE 10 2012 024 120 A1, DE 195 31 167 A1, DE 10 2007 042 487 B4, DE 25 42 436 A1, DE 10 2007 040 077 B4, DE 2 321 648 A1, DE 38 29 210 A1, DE 10 2005 048 835 A1, DE 10 2007 018 792 A1, DE 691 07 927 T2. Anyhow, any procedure for a production method allowing for a preferably high degree of automated production of more or less arbitrary sealing rings is not yet familiar.

### SUMMARY

It is an object to provide a device or a method for production of sealing rings which allows for rendering the production more straightforward, faster or more cost-effective or preferably flexible. It is also an object to provide the device such that preferably a high number of different variants of sealing rings can be produced, without the need of any sophisticated re-configuration of the device. The object may also comprise a configuration of the device or method such that an actuation by means of a control device can be allowed in preferably easy manner for a high degree of automation. Not least, it is an object to render the method such that it may be optimized in an easy manner for a predefined kind of produced sealing rings, even in case that no standard materials can be provided or in case standard dimensions may not be met.

In an embodiment, the present invention provides a device for producing sealing rings made of an endless-material. The device includes a feeder unit configured to convey and position the endless-material in at least one cutting position, a cutting unit configured to cut off a section of the endless-material, at least one gripper unit configured to grip and to displace the endless-material or the section of the endless-material and to control a displacement of at least one free end of the section of the endless-material along a predefined path of motion in and/or out of a wetting position, a control device connected with at least one of the feeder unit, the at least one gripper unit, and the cutting unit, and a feeding device for a bonding fluid. The feeding device is connected with the control device and is arranged so that the bonding fluid is deposited in a controlled manner on the at least one free end of the section of the endless material in the wetting position. Advantageous embodiments of the invention are elucidated in the respective dependent claims. The features of the following described embodiments can be combined with each other, unless explicitly denied.

### BRIEF DESCRIPTION OF THE DRAWINGS

The present invention is described in greater detail below on the basis of embodiments and of the drawings in which:

FIG. 1 shows a lateral view of a schematic illustration of a device according to an embodiment where a string of endless-material is arranged in a feeder unit and is fed by means of rolls in longitudinal direction;

FIG. 2 shows a lateral view of a schematic illustration of a device according to an embodiment where the free end of the string has been displaced as far as to an end switch;

FIG. 3 shows a lateral view of a schematic illustration of a device according to an embodiment where the feeding has been stopped, and the longitudinal section of the string arranged on the cutting unit is positioned in a cutting position in which a cutter shall contact the string;

FIG. 4 shows a lateral view of a schematic illustration of a device according to an embodiment where both free ends of the cut section have been moved towards each other on circular paths in opposing senses of rotation by 90° and have been transferred in the wetting position in which bonding fluid can be deposited;

FIG. 5 shows a lateral view of a schematic illustration of a device according to an embodiment where a sealing ring has been produced by transferring the free ends in a bonding position resp. pressing position, also in this case by displacement on a circular path;

FIG. 6 shows a lateral view of a schematic illustration of a device according to an embodiment;

FIG. 7 shows a lateral view of a schematic illustration of a device according to an embodiment showing a pivot bearing for the respective disk, and further a pivot bearing for the drive unit; and

FIG. 8 schematically illustrates variants of a feasible sequence of a method according to the invention.

### DETAILED DESCRIPTION

There is provided a device for production of elastic, flexible, especially elastomer sealing rings made of endless-material, especially made of cords, comprising
a feeder unit configured for conveying and positioning the endless-material resp. a corresponding section to be cut thereof in at least one cutting position;
a cutting unit configured for cutting off a section of the endless-material;
at least one gripper unit configured for gripping and displacing the endless-material or the section;
a control device which is in connection with the feeder unit, with the at least one gripper unit and/or with the cutting unit.

According to the invention, it is suggested that the at least one gripper unit be configured for controlled displacement of at least one free end of the section along a predefined resp. predefinable path of motion in a and/or out of a wetting position, wherein the device further comprises a feeding device for bonding fluid which is in connection with the control device and which is or can be arranged such that bonding fluid can be deposited in a controlled manner on the at least one free end arranged in the wetting position. This allows for standardization and automation of the use of bonding fluid resp. adhesive, especially also the deposition of bonding fluid according to exact input requirements, with great cleanness, and within a narrow tolerance range, especially at exactly predefined position, especially neither with excessive nor with too little bonding fluid. The endless-material may e.g. be extruded. The device can be arranged downstream of an extruder.

The cutting unit may comprise e.g. at least one blade which can be displaced especially orthogonally relative to the string. Optionally at least two blades can be provided, which can be displaced in the manner of scissors relative to each other resp. which are pivoted in a common pivot.

The cutting position thereby preferably corresponds to a point resp. a position of the section in which the string can both be cut and gripped, especially gripped in the null position of the gripper unit. This then allows for guiding the cut section from the cutting position resp. null position in the wetting position resp. bonding position auf preferably exact manner. Preferably the cutting position is arranged between the feeder unit and the at least one gripper unit.

According to one embodiment the at least one free end or the at least one gripper unit is displaceable in a controlled manner in a bonding position, in which the two free ends of the section can be docked to one another, especially on a path of motion corresponding to a circular path. This allows for automation not only of the deposition step, but also of the bonding step, i.e. automation of the complete production of the ring.

According to one embodiment the at least one free end is displaceable in a controlled manner in a bonding position which is arranged between two gripper units which are respectively arranged in a null position during cutting, especially aligned and/or centrally between the null positions, especially on a circular path. This allows for a simple method resp. for a straightforward setup of the device, especially irrespective of any specific length of the cut section. The bonding position may remain identical. Not least, a compact machine design can be provided.

According to one embodiment the bonding fluid feeding device exhibits at least one feeding unit for feeding of bonding fluid, which is positioned or aligned with respect to a/the path of motion of the section or of the at least one gripper unit, especially radially or orthogonally. This favors exact punctual or two-dimensional deposition of bonding fluid. For example, the feeding unit exhibits an outlet which dimensions at least approximately correspond to the dimensions of a cross-section profile of the section. Optionally the feeding unit can be movable, especially concentrically pivotable around the wetting position, such that anyhow, also for a relatively great frontal area, two-dimensional deposition of the bonding fluid can be realized.

According to one embodiment the bonding fluid feeding device exhibits two feeding units which respectively exhibit an outlet being aligned with or arranged in one of two wetting positions, especially being directed downwards. This allows for deposition of bonding fluid on both free ends, especially simultaneously, whereby the resilience of the adhesive bond can be optimized, depending on the type of bonding fluid. In particular, different types of bonding fluid can be deposited on both ends, especially respectively one component of a two-component adhesive. This may provide for advantages for specific materials of the seal. Also, advantages in view of supply of the adhesive can be realized. In particular, conglutination of the respective feeding unit can be avoided, as each component may be supplied separately from the other component. Further, the method of deposition/wetting can be optimized, e.g. relating to the respective viscosity.

According to one embodiment the bonding fluid feeding device is arranged above the at least one gripper unit. This allows for deposition resp. wetting by effect of gravitational forces, in addition to advantages relating to the arrangement of individual components of the device (especially clearance for string section). Depending on the viscosity of the bonding fluid, this may provide great advantages, especially with regard to a preferably easy way of apportioning.

According to one embodiment the feeder unit configured for guiding the endless-material to the gripper unit and along and past the gripper unit to at least one further gripper unit, especially to a further gripper unit in opposing position. This allows for the gripping of both free ends of the section in an easy manner. In particular, the ends can be gripped in preferably exact manner at the desired points and can be displaced in correspondingly exact manner in the respective position. Preferably, the gripping of the free ends is carried out in such a position that the free ends slightly protrude the gripper units, e.g. 0.5 mm.

According to one embodiment the at least one gripper unit exhibits a feedthrough for the section to be cut. This allows displacing the string through/via the respective gripper unit and thereby also arranging it in the desired gripping position. Further, this allows for an arrangement of several gripper units in series, whereby the method can be facilitated in advantageous manner.

According to one embodiment the device comprises a land or a guiding or a slide contour, which is arranged such that the endless-material or the respective section can be guided away from the cutting unit and along a predefined path of motion or along a predefined contour, especially at least approximately linearly, especially guided to a further gripper unit. This facilitates the gripping and increases accuracy. In particular, the land resp. the guiding rail can be made of aluminum. Preferably, the land is arranged on a disk, especially eccentrically. Preferably, the land exhibits a length which is smaller than a diameter of the disk. This allows for providing a clearance for a loop-shaped arrangement of the section, especially between two land sections. Further preferably, the land is provided by two sections which are respectively arranged on a disk and which can be rotated together with the disk when the disk is rotated.

Thereby, the land resp. the guiding or slide contour may constitute both an underlayment support (in height direction) and a lateral guiding (in cross direction). This may ensure that the section to be cut initially remains orientated essentially in longitudinal direction (feeding direction). As soon as the section is compressed, it may decouple from the land, especially also from the lateral guiding, such that the section curves downwards due to gravitation. According to a variant, the lateral guiding is constituted by a lateral area of the (respective) disk. As soon as the section has been gripped by a gripper unit, also the land can be displaced, especially in order to allow the section to curve downwards in an arc-shaped resp. in a loop-shaped or in a semi-circular manner due to gravitation, especially also in case the section is composed of very dense, strong material. Since the land can be displaced out of a path of motion of the section, especially when being pivotable in a pivot of the respective disk, also an ejection can be realized in a particularly elegant manner, especially simply by opening at least one of the gripper units and releasing (gravitation) the section (waste) downwards.

According to one embodiment the feeder unit is arranged resp. orientated in alignment with the gripper unit and with at least one further gripper unit. This allows for comparatively easy feed (feeding) to the grippers.

According to one embodiment the at least one gripper unit is aligned in eccentric position on a pivotable motor-driven disk. This allows for a particularly straightforward robust setup on the one hand and for easy control resp. very exact positioning on the other hand. The arrangement of the gripper unit(s) described herein allows for providing merely one single process step of gripping the sections for the whole process up to the step of bonding the free ends of the section. As the gripping can now be carried out with high accuracy before or after the cutting, also the wetting and the following bonding of the free ends can be carried out in comparatively exact manner, without the need of any further control again of the gripper units.

According to one embodiment the path of motion of the at least one free end corresponds to a circular path at least in sections. This allows for exact positioning on the one hand and for a favorable setting of the device on the other hand, especially for a setting with identical components for both free ends.

According to one embodiment the device exhibits at least one disk which is or can be arranged in predefined pivot positions by means of a drive unit, and on which the (respective) gripper unit is arranged eccentrically. This also provides for a straightforward, robust design. Thereby individual pivot positions resp. pivot angles can be correlated with a respective null position resp. with the cutting position resp. with the wetting position resp. with the bonding position.

According to one embodiment the device comprises two gripper units which are arranged in eccentric position on two disks which are pivotable contrarily to each other, especially when engaging each other, in kinematic dependency. Thus, a pivot angle of one of the disks conditions a specific pivot angle of the other disk, especially the same pivot angle. This allows the gripper units to move exactly synchronously with respect to each other, be it with the same pivot angle, be it with differing pivot angles. The disks may respectively exhibit a gearing which together constitute a spur gearing. The disks preferably exhibit the same diameter resp. the same number of teeth. This favors a symmetric arrangement of the gripper units.

According to one embodiment the device comprises two gripper units which respectively can be displaced out of the null position resp. out of the wetting position in a bonding position, especially synchronously or simultaneously in kinematic dependency, in which the two free ends of the section can be docked to one another. This allows for exact positioning of the ends by means of the gripper units, wherein only one of the gripper units has to be driven, and this optionally also allows exerting a predefined pressure force. Thereby the null position preferably corresponds to the cutting position, i.e. without any displacement of the gripper unit. In other words: When the section/string is arranged in the cutting position, the gripper unit resides in the null position.

According to one embodiment the device comprises two gripper units and is configured for displacing the two free ends of the cut section therewith respectively out of a null position, in which the section is arranged after having been cut, along the respective path of motion in the wetting position, especially simultaneously and/or on asymmetric paths of motion, in order to remain there for the deposition of bonding fluid, and is configured for docking to one another the free ends thereupon in a bonding position, especially frontally, especially by respecting a predefined retention time. This allows for controlling the whole process from the cutting step as long as to the step of bonding by the position of the gripper units. The gripper units may grip the section in preferably exact manner within a narrow range of tolerance for the gripping position, and may then hold resp. fix it as long as to the step of bonding. There is no need for any further gripping step. Thereby the bonding can be carried out in particularly exact and well reproducible manner.

Thereby the bonding position can be arranged on a line resp. at least approximately aligned between the null positions of the gripper units. Thereby the bonding position can be arranged in the middle between the null positions of the gripper units. Thereby, asymmetric paths of motion can be understood as e.g. two circular paths which are driven through in opposing directions of motion. The complete device can be arranged, together with a spool package for the endless-material, on a frame which e.g. has the dimensions of 1 m width, 1 m depth and 1 m in height. Hereby a compact arrangement of the components of the device can be realized, and also the method can be carried out within little space, especially less required space as compared to a place of work for manual conditioning.

The device may exhibit at least one test option, especially according to VPA2-standard. In particular, a random measurement of the tractive forces transmitted in the bonding spot and/or a random or continuous especially optical measurement of an offset at the bonding spot can be carried out, with corresponding adjustment option. Hereunto, the gripper units can be re-positioned at the disks and/or the feedthrough of the respective gripper unit can be bedded in an adjustable manner in a direction crosswise to the feeding direction.

At least one of the above mentioned objects is also solved by a control device configured for actuating a device for production of sealing rings made of endless-material, especially configured for actuating a device described above, wherein the control device comprises a memory in which are stored at least one type of data of the following group: position data of a null position of at least one gripper unit, position data of at least one wetting position, position data of a bonding position, data relating to a path of motion of the at least one gripper unit, especially with respect to a rotary actuation of a drive unit, data about the characteristics of at least one type of endless-material; wherein the control device exhibits a communication interface connecting at least one of the following components of the device: feeder unit, cutting unit, gripper unit, bonding fluid feeding device. Hereby, control of the production method can be carried out with regard to a plurality of parameters, be it individually, isolated, or be it in combination with each other, such that the device can be used in particularly flexible manner, resp. such that the device can easily be adapted to specific sealing rings.

At least one of the above mentioned objects is also solved by the use of a control device in a device for production of sealing rings made of endless-material, especially in a device as described above, in order to define at least one wetting position and a bonding position of free ends of a section of the endless-material cut into lengths, especially for actuating at least one drive unit for displacing at least one gripper unit, especially on a circular path. Hereby important process steps for the bonding of the ends can be automated. The bonding can be made in reproducible manner. This also facilitates e.g. a random quality control.

At least one of the above mentioned objects is also solved by the use of at least one pivotable disk in a device for production of sealing rings made of endless-material, especially in a device as described above, in order to position at least one gripper unit in a null position for gripping the endless-material and in a wetting position for depositing bonding fluid on at least one free end of a cut section of the endless-material and further in a bonding position for bonding the two free ends of the section, especially use of two disks which intermesh in a form-fit manner when being rotated in opposite rotating directions. Hereby the positioning and the alignment in the respective position can be carried out in very exact manner, especially synchronously, with comparatively straightforward control. Thereby the gripper unit can be mounted eccentrically on the disk, especially mostly outwards, especially in such a manner that the gripper unit is arranged at least approximately succinctly with regard to the disk's outer contour and does not overlap the disk's outer contour. This may ensure that two gripper units arranged on two intermeshing disks can be passed along each other. In particular, the gripper units are positioned such that they protrude only as far as to the beginning of the gearing of the disk, ensuring a radial distance of e.g. 0.5 mm. Thus, the gripper units do not succinctly terminate with the disk, but terminate slightly before and radially a little further inwards.

At least one of the above mentioned objects is also solved by the use of a device as described above in connection with an extruder or an alternative assembly for production of a string. Hereby the production beginning with raw material as far as to the final product (sealing ring) can be provided from one source resp. within the same manufacturing shop resp. at the same site.

At least one of the above mentioned objects is also solved by a method for producing elastic, flexible, especially elastomer sealing rings made of endless-material, especially made of cords, comprising the steps:
feeding and positioning the endless-material in at least one cutting position;
cutting off a section of the endless-material in the cutting position;
gripping and displacing of the section by means of at least one gripper unit;
   wherein according to the invention, the step displacing of the section is carried out after the cutting off step and comprises controlled displacement of at least one free end of the section along a predefined path of motion in a and/or out of a wetting position, especially along a path of motion (respectively) corresponding to a segment of a circle, further comprising the step: depositing bonding fluid onto the at least one free end which is positioned in the wetting position. Hereby the production can easily be automated by carrying out displacement of the free end in the respective position. The section does neither have to be hold manually nor aligned.

The step of displacing can be carried out around a pivot axis, especially around a pivot axis being orientated in cross direction y, crossways to the feeding direction x. The step of deposition can be controlled in dependency of the point in time of reaching the wetting position, especially can be started directly at the time of reaching, or also shortly before, e.g. 1 second before, for example when the bonding fluid has a great viscosity and may only be supplied slowly. Thereby the step of feeding and positioning may comprise feeding a free end of the endless-material to a gripper unit which is farther offset with respect to the feeder unit, wherein the endless-material thereby can be fed via the cutting unit and via a/the gripper unit being arranged closer to the cutting unit, especially along a contour or along a land. The step of feeding and positioning may also comprise arranging a land or a guiding or a slide contour in such a manner that the path of motion of the section can be defined therewith, especially a linear path of motion in the feeding direction x. Likewise folding away or retracting the land can be comprised, especially immediately after the section has been gripped. This favors autonomous shaping of an arc-shaped geometry of the section. Thereby the step of gripping and displacing may comprise a pivot motion and/or alignment of a frontal area of at least one free end of the section in an at least approximately horizontal plane and/or may comprise shaping of an arc-shaped contour or of a contour like a segment of a circle, especially of a semicircular contour of the section and/or may comprise reduction of the distance of the free ends with respect to each other, especially by half the distance.

Thereby, during gripping, the gripper units can be arranged at maximum distance with respect to each other, the distance being equal or smaller than the minimum length of the section to be cut or of the circumference of the ring to be produced. This allows displacing the gripper units without any stretching of the section, especially in an arrangement of the gripper units on wheels/disks of a spur gearing. Thereby the bonding fluid can be deposited by means of a feeding unit or a dosing pump being in alignment with the wetting position, wherein the step of deposition is a step controlled by a control device, especially with respect to the quantity or a minimum retention time. Also, the bonding fluid can be deposited by means of a bonding fluid feeding device onto the two free ends of the section, the bonding fluid feeding device being in alignment with two wetting positions.

According to one embodiment the method further comprises the following step carried out after the deposition of bonding fluid: displacing of at least one of the free ends of the section, especially of both free ends out of the wetting position in a bonding position for positive substance jointing of the free ends together by means of the deposited bonding fluid, especially by a rotary motion (respectively) along a path of motion corresponding to a segment of a circle. This kind of motion can be realized in comparatively simple and exact manner, as already described above. In der bonding position the free ends can be docked frontally to one another, especially with predefined pressure, especially during a predefined period. Especially when protruding the respective gripper unit, the ends can be fixed in the respective gripper unit. Thereby the path of motion between the null position and the wetting position and/or the bonding position may describe a segment of a circular path, especially with a pivot angle of 90° resp. 180°.

According to one embodiment the method comprises the step: displacing of both free ends out of the wetting position in a bonding position between two null positions, in which is arranged respectively one of two gripper units during cutting, especially in alignment with and/or centrally between the null positions, especially on a circular path. This allows for bonding the ends always in the same manner and at the same position, irrespective of the length or type of the section.

According to one embodiment the step of displacing the section resp. the gripper unit(s) further comprises providing a clearance for loop-shaped arrangement of the section, especially between two land-sections. This can both be carried out especially by a rotary motion.

According to one embodiment the step of displacing the section resp. the gripper unit(s) further comprises turning away at least on land around its cross axis for providing a clearance for loop-shaped arrangement of the section. This can both be carried out by rotation of a disk to which the land is attached.

According to one embodiment the method comprises the step: displacing the face sides of both free ends out of an alignment averted from each other, especially out of an exactly opposed alignment, in an alignment frontally facing to each other in the bonding position, especially by two rotary motions or on two circular paths. This arrangement allows for a path of motion of the section resp. of its free ends which can be realized by a robust, exactly and easily controllable mechanism.

According to one embodiment the method further comprises the following step carried out after the boning of the free ends: moving back of the at least one gripper unit out of the bonding position in a null position, especially on a circular path, especially by a rotation angle of 180°. This allows re-positioning of the gripper units by means of the same drive unit, especially on the same path of motion. Thereby, the step of moving back can be carried out with the same or with opposing direction of rotation.

According to one embodiment the method further comprises the step: ejection of the sealing ring, especially in a predefined direction or with a predefined impulse. This may facilitate automation, especially in view of different types/length of sealing rings which should be packaged or finished separate from each other.

According to one embodiment, during displacement, the at least one gripper unit is guided along a circular path with changing sense of rotation, especially by means of a disk. Hereby constructive advantages may be realized, be it with respect to the respective disk, be it with respect to the arrangement of a drive unit. This may also allow for especially short tracks of displacement, depending on the arrangement of the gripper units. According to a variant a rotation between the null position and the bonding position is carried out by a rotation angle of at least approximately 180°. Then, the sense of rotation may also be kept.

According to one embodiment, during displacement, two gripper units are guided on circular paths with changing senses of rotation. In particular, this may be realized by a spur gearing, which can be actuated easily and which can be positioned in predefined rotating positions. Therefore, a respective disk may e.g. exhibit a diameter of 150 mm and may exhibit 100 teeth.

According to one embodiment, during displacement, two disks engaging each other are rotated, especially by means of a drive unit engaging one of the disks, especially by means of a gear pinion. This allows for accurate synchronism without any complex control technique.

According to one embodiment the at least one gripper unit is moved between three pivot positions, one of these positions corresponding to a null position for gripping the section, one of these positions corresponding to the wetting position, and one of these positions corresponding to the bonding position, wherein the pivot positions preferably are offset by 90° to each other. This provides a straightforward setup resp. a simple method, respectively with advantages in the respective position, especially with regard to accessibility or flexibility.

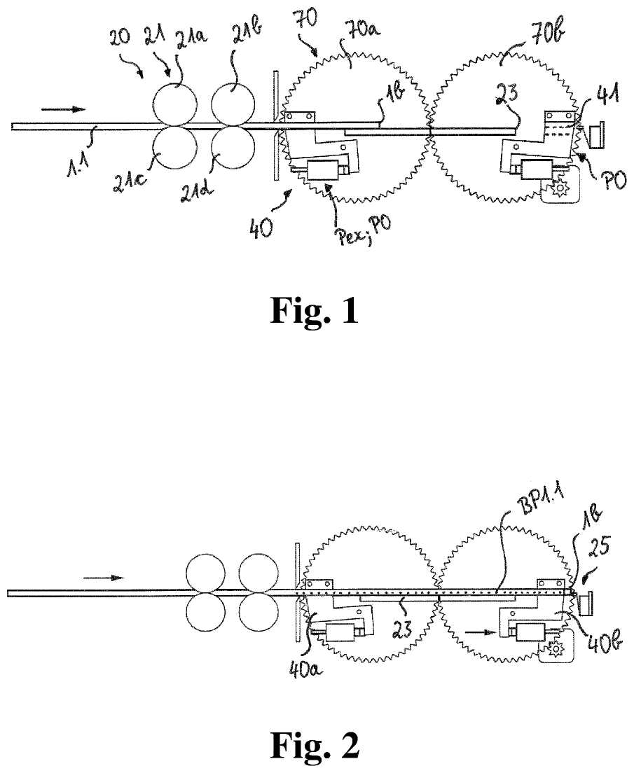

In FIG. 1 a string 1.1 of endless-material 1 is arranged in a feeder unit 20 and is fed by means of rolls 21; 21a, 21b, 21c, 21d in longitudinal direction x. The string 1.1 is guided through a cutting unit 30 or over it, and further through two gripper units 40; 40a, 40b, respectively by means of a feedthrough 41 therefrom. Thereby a free end 1b of the string 1.1 is guided via a land 23, especially as long as it reaches an end switch 25 (position switch) which is arranged behind the (in feeding direction) second gripper unit 40b. The respective gripper unit may comprise bipolar lifting magnets with end position fixation. The respective gripper unit is arranged in an eccentric position Pex with the eccentricity ex on a disk resp. on a gear wheel 70; 70a, 70b. The disks interlock by means of a form-fit contour of the type of a gearing 73 and provide for a spur gearing.

The string 1.1 is displaced along a path of motion BP1.1 which at least approximately corresponds to a straight line resp. to the feeding direction x. Thereby the respective gripper units remain in a null position P0. Any motion in cross direction y or in vertical direction z is neither desired nor required.

FIG. 1 shows a situation in which the string 1.1 is displaced via the feedthrough of the front gripper unit 40a and via the land 23 as far as to the rear gripper unit 40b arranged in line thereto. Both gripper units are opened and are arranged in the null position.

FIG. 2 shows a situation in which the free end of the string 1.1 has been displaced as far as to an end switch 25. As soon as the end switch 25 is reached, the rear gripper unit can be closed. The rear gripper unit (rear in feeding direction) then can grip the free end of the string and fix it in that position. Thereby the end switch can be configured as mechanical or also e.g. as optical switch. The front gripper unit 40a is still opened.

Now, the string can be displaced against the rear gripper unit, which evokes the string to curve resp. to form a shape of a segment of a circle. Hereby a desired length of the section to be cut can be adjusted irrespective of the distance of the gripper units with respect to each other.

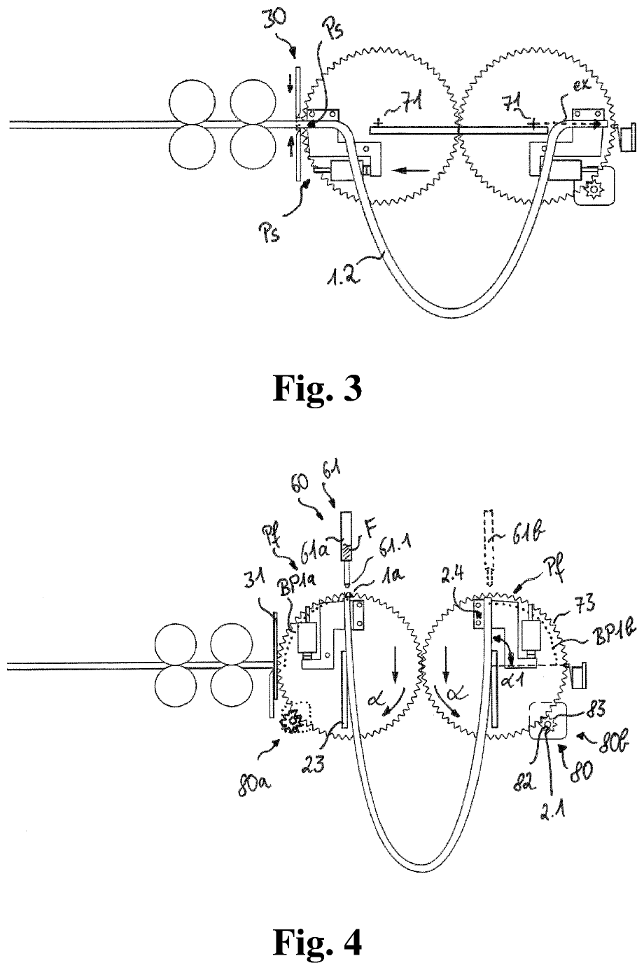

In FIG. 3 a situation is shown in which the feeding has been stopped, and the longitudinal section of the string arranged on the cutting unit is positioned in a cutting position Ps in which a cutter shall contact the string. In other words: The feeder unit has realized a desired definition of length for the section to be cut, for example by measurement of length or feed rate at the rotating rolls, and has been blocked in order to allow the cutting to be done in a preferably exactly predefined longitudinal position. The length may for example be adjusted by the number of steps of a step motor, e.g. 1 step=1 mm.

Thereby the string 1.1 has been displaced in such a manner against the rear gripper unit 40b resp. against an end switch that the string curves in an arc-shaped manner, especially downwards due to gravitation. It has been found that the land resp. the guiding rail on which the string previously has been displaced in the feeding direction, thereby does not necessarily have to be displaced, depending on the material. Due to the curving shape, the string autonomously slips of the guiding rail, especially a string made of cellular rubber. Thereby the string has been pushed in a buffering clearance V0 between the gripper units, which clearance V0 is open downwards resp. which is boundless at least in a region of e.g. 15 to 25 cm. In particular, this clearance V0 for variations in length of the string before the step of cutting to length is open downwards and exhibits dimensions in height which correspond to at least half the diameter of a ring of maximum diameter for which the device should be designed. This allows for an elegant concept for gripping and positioning of sections of different length, without the need of any adaption of the process to the length respectively desired.

As soon as the desired length has been reached resp. as soon as the feeding has been stopped, the front gripper unit can be cut. Now, the cutting to length resp. the cutting of a section 1.2 of the string 1.1 can be carried out by means of a cutter 31 of the cutting unit 30.

Thereupon, the cut section 1.2 can be displaced by turning the disks against each other. Therefore, a drive unit 80 comprising at least a step motor 80a, 80b engages at least one of the disks by means of a gear 82 with form-fit contour resp. by a gearing 83, whereby the free ends are displaced from the null position P0 in the wetting position Pf, namely by a pivot angle of 90°, as can be seen in FIG. 4. A pivot angle α of the driven disk here corresponds to the pivot angle α1 for passing from the null position to the wetting position.

Thereby the free ends of the section clamped in the respective feedthrough 41 are displaced along circular arcs BP1a, BP1b at least approximately corresponding to a path of motion BP40 of the respective gripper unit, resp. concentrically thereto. In the wetting position Pf both free ends are arranged with its face sides facing upwards. In the embodiment presently illustrated, one of them is wetted. Optionally both of them can be wetted.

A bonding fluid feeding device 60 is arranged above the (respective) wetting position Pf and comprises one or two feeding units 61; 61a, 61b, respectively with an outlet 61.1. During the step of deposition of bonding fluid F the wetting position Pf can shortly be retained, e.g. a few seconds. Though, optionally, also a continuous displacement via the wetting position Pf can be carried out (without any stop), depending on the kind and manner of supplying bonding fluid, or depending on the viscosity of the bonding fluid.

According to the situation shown in FIG. 4, both free ends 1a, 1b of the cut section 1.2 have been moved towards each other on circular paths in opposing senses of rotation by 90° and have been transferred in the wetting position in which bonding fluid can be deposited, optionally on one or on both free ends resp. on its frontal areas. Thereby the (respective) land 23 can be turned away together with the disks.

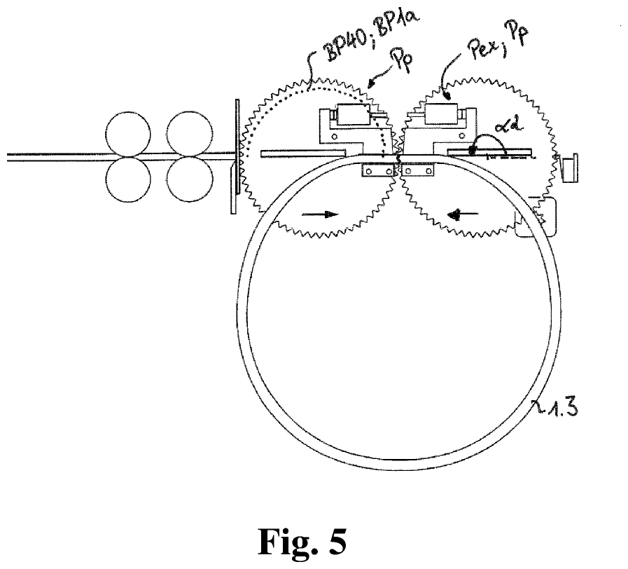

According to the situation in FIG. 5, a sealing ring 1.3 has been produced by transferring the free ends in a bonding position resp. pressing position Pp, also in this case by displacement on a circular path. The pivot angle α2 from the null position as far as to the bonding position corresponds to 180°, and the angle between the wetting position and the bonding position corresponds to 90°.

In FIG. 5 is shown a situation in which both gripper units resp. both free ends 1a, 1b of the cut section 1.2 have been moved on circular paths towards each other by further 90° in opposing senses of rotation and have been transferred in the bonding position in which the free ends can be docked frontally to one another, especially also with a predefined pressure which can be adjusted e.g. in dependence of an overlap or an excess length of the ends with respect to each other. Thereby the excess length is for example 2 mm.

The face sides of the section have been displaced by two rotary motions on two circular paths out of an averted, exactly opposing orientation in an orientation frontally facing towards each other towards the bonding position.

In this position the disks can be blocked, e.g. for a few seconds, in order to ensure a durable, resilient bonding. Thereupon the Ring 1.3 can be ejected or extracted, and the disks can be turned back or turned further until the respective null position is reached again. In other words: The drive unit resp. the step motor may also be configured for changing sense of rotation.

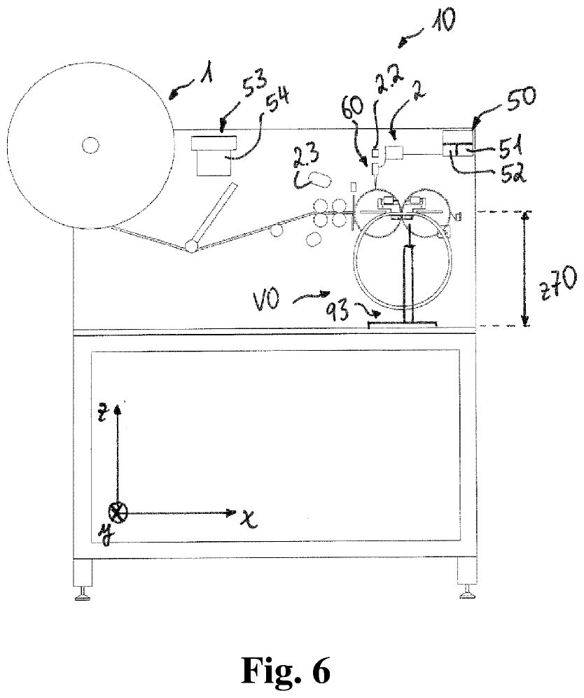

FIG. 6 exemplarily shows a device 10 for production of sealing rings, comprising a measuring device 2 with at least one first Sensor 2.1, especially an angle meter unit or a pivot encoder, at least one time recording unit 2.2, at least one optical measuring unit, especially a camera 2.3, and at least one pressure sensor 2.4, especially integrated in the respective gripper unit. The measuring device 2 is coupled to a control device 50 which comprises a processing unit 51, a memory 52, an input-output unit 53, especially with visual user interface, and a communication interface 54, especially for wireless communication.

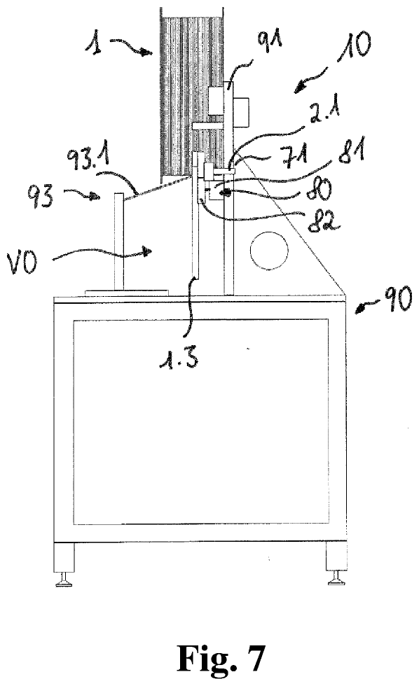

Well perceptible in FIG. 7 is a respective pivot bearing 71 for the respective disk, and further a pivot bearing 81 for the drive unit. The individual components of the device 10 are arranged on a frame 90 and are fixed on a plate 91, especially also a reservoir 93 resp. a coiler for the endless-material 1, and also a guiding 93.1, especially a rod being inclined with respect to the horizontal plane for receiving ejected finally bonded sealing rings.

The respective disk 70a, 70b is mounted in a mounting position/height z70 in pivot bearing 71, wherein the mounting height z70 preferably is bigger than the maximum diameter of the rings to be produced, especially at least 35 to 40 cm. This allows for moving the ring freely within the clearance, irrespective of its size. The mounting height z70 can be measured with respect to a plate arranged in the xy-plane, and is for example 50 cm or 60 cm. With such a mounting height z70 a great clearance V0 for producing the rings and optionally also for temporarily storing the rings can be realized, e.g. for charges of 100 or 200 rings.

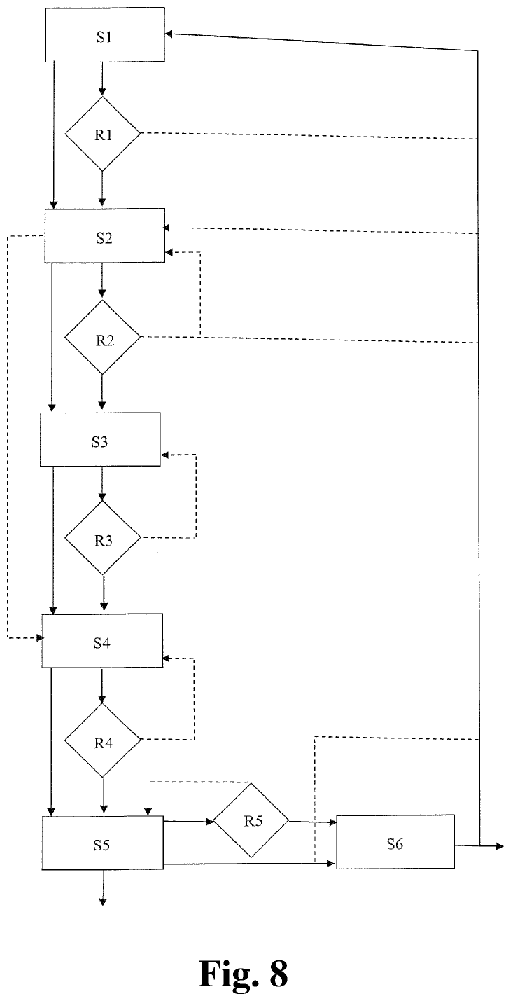

FIG. 8 schematically illustrates variants of a feasible sequence of a method according to the invention, elucidating six individual steps which preferably are carried out with the chronology presently described.

Firstly, in a first step S1, a conveying of a string 1.1 of the endless-materials (by actuating der feeder unit 20) as far as to at least one gripper unit 40a, 40b as well as a positioning of the string 1.1 relative to a cutting unit 30 according to a desired length of the section 1.2 to be cut is carried out, namely in a cutting position Ps (stop of feeding). Therefore, e.g. a length of 20 cm or 25 cm of the string 1.1 can be unwound. Thereby the length of the section may correspond to the distance of the gripper units with respect to each other, or can be greater. In the embodiment presently described the string is gripped by two gripper units such that the length of the section at least corresponds to the distance of the gripper units with respect to each other.

Thereby, in a first point of control R1, the feeding and positioning can be controlled, especially by predefining parameters for a/the feeder unit 20 such that the first step S1 can be controlled especially with respect to a specific position (feeding stopped) or its adjustment or also with respect to a feeding speed or a pressure of the rolls of the feeder unit exerted on the sealing material.

According to one embodiment the string is fed in an at least approximately horizontal plane. In order to facilitate gripping of the free end, a land or a slide contour can be provided as a gliding support for the string. The land can be aligned with the gripper unit. The land can be arranged on the respective disk.

During resp. at the end of the first step S1 the string 1.1 is thus arranged in a cutting position Ps in which the section can be cut off the string later on with the desired length. In case the length shall be greater than the distance between the gripper units, the string can be transferred against one of the gripper units (feeding against the rear gripper unit), especially after the free end of the string of der gripper unit has been gripped. Thereby the string can be arranged in a U-shape, especially by arranging the string between a further, second gripper unit 40b, which already has gripped the string hat, and a first gripper unit 40a, relative to which the string is still displaceable, according to an arc geometry or according to a segment of a (semi)circle (feeding against an end which already has been gripped). Depending on the desired length of the section, the string in this connection takes a U-shape with characterizing height. The step 1 may thus also comprise the gripping and positioning resp. holding in position of a/the free end of the string. Thereby the gripping can comprise a first gripping of the free end resp. of the end arranged rearmost with respect to the feeding direction (after having carried out the step of cutting) on the one hand, and a second gripping of the string resp. of the first end arranged in front with respect to the feeding direction (after having carried out the step of cutting) on the other hand. The first gripping can be tuned to the feeding step. In particular, at the point of control R1, a signal of an end switch can be generated in order to signal that the free end of the string now has reached a null position in which the string can be gripped. The end switch can be arranged especially aligned with and behind a feedthrough of the gripper unit, and can be actuated by the free end itself. Optionally the feeding can be stopped in order to carry out the first gripping (positioning). For the second gripping, the feeding is/will be stopped.

According to one embodiment the first step S1 also comprises a step of retracting, folding back or displacing or pivoting of the land, namely in a situation when the length of the section shall be greater than the distance of the gripper units. Hence also the first point of control R1 may comprise a servo loop for a mechanism for displacement of the land. Preferably the land is pivoted, together with a respective disk, around a pivot bearing of the disk.

Thereupon a cutting off the section resp. a through-cutting of the string can be carried out in a second step S2, especially by means of one or two cutters 31 of the cutting unit 30 being guided orthogonally with respect to the string.

In a second point of control R2 especially cutting parameters can also be controlled, for example an exerted force, a motion speed of the cutters, and/or the geometry of the cutting edge obtained, for example by means of at least one optical measuring unit 2.3. In case the cutting edge is not clean, especially not plane, the first step S1 can be repeated (chain line). In particular, the string can be cut to length again, especially after having ejected the faulty string section. At the end of the second step S2 is provided a section cut to length having cutting edges or free ends which are adapted for positive substance jointing.

Thereupon in a third step S3 a gripping of the cut free end and a displacing of the section 1.2 can be carried out, especially such that both free ends of the section can be wetted with bonding fluid. Thereby, the gripping of the cut free end may also have been carried out in step S1 or S2. Thus, in a third point of control R3 especially the displacement of the free ends can also be controlled, especially by continuous position detection or position control. Thereby the step of displacing the free ends especially can be carried out on circular paths, especially with opposing pivot angle. Thereby the gripper units can be moved towards each other, especially out of a position with maximum distance as far as to half this distance with respect to each other. At the end of the third step S3 the free ends are thus accessible for bonding fluid F, especially with the frontal areas facing upwards and in alignment with an at least approximately horizontal plane. In the third point of control R3 the position detection resp. position control can also be carried out in an elegant manner by arranging both gripper units on intermeshing disks, only one of the disks being driven. Thus, one of the disks resp. gripper units can be positioned indirectly by the other disk, which provides for a straightforward control and for a robust process.

The wetting position Pf does not necessarily have to differ from the cutting position resp. null position. Rather, according to a variant, a deposition of bonding fluid in the cutting position resp. null position also can be carried out. Thus, FIG. 8 indicated that the step S3 optionally may be overleaped. However, it has been found that it is advantageous especially with respect to the arrangement of components of the device to choose a wetting position which is different from the null-resp. cutting position.

As soon as the free end/s are arranged in the wetting position Pf, in a fourth step S4 the deposition of bonding fluid can be carried out, and optionally also a step of at least partially drying. Thereby the wetting position Pf may correspond to the highest point of a pivotable disk on which the respective gripper unit can be arranged. In a fourth point of control R4 on the one hand the deposition can be carried out, and on the other hand the drying or the step of retention can be controlled, especially with respect to the type or quantity of the bonding fluid deposited or with respect to a retention time in the wetting position. Thus, at the end of the fourth step S4 the free end/s are configured for being interconnected. Thereby, however, the desired drying period may also include a time span which is required for a displacement of the gripper units from the wetting position to a bonding position.

In a fifth step S5 a bonding of the free ends of the section is carried out, especially comprising a displacement from the wetting position to the bonding position, whereby the free ends can be contacted with each other. Thereby the displacement can be carried out especially exclusively by a pivot motion. Thereby the free ends can be docked to one another exclusively by a pivot motion, especially respectively around pivot points which are arranged one after another in alignment with the feeding direction.

In a fifth point of control R5 on the one hand the displacement towards the bonding position can be monitored/controlled (which can be done in the manner described above), on the other hand the contacting of the free ends can be monitored, especially as regards the alignment with respect to each other, and/or as regards a pressure and/or a retention time in the bonding position. Hereby e.g. optical measuring units or pressure sensors can be applied. At the end of the fifth step S5 a ring is produced which has been made by positive substance jointing of the section.

It has to be pointed out that the gripping of the ends of the profile in the desired position may already be sufficient for defining all further positions of the free ends during the process. The grippers only have to be closed once. Thereby the corresponding position of the free ends can be predefined both for the deposition of adhesive and for the contacting resp. for the pressing against each other. For optimizing or controlling of the gripping and of an adjusting of the string, which step is optional therefore, an optical monitoring can be carried out, especially by means of a camera being arranged in the region of the null positions or being directed thereto. This configuration of the process allows for great accuracy, and the effort for adjustment and re-positioning or corrections can be minimized. In particular, when the gripper units and the disks resp. gear wheels are configurated as rigid elements, the positioning of the free ends may already be optimized by carrying out the feeding of the ends of the profile in particularly careful resp. exact manner.

Optionally the process can be terminated at this phase, resp. it can begin again at step S1, depending on whether an ejection of the produced ring is required or desired. The step S5 may optionally also comprise a step of opening resp. releasing of the at least one gripper unit. Thereby the opening of the respective gripper unit may also be carried out such that this step includes an ejection, or at least a slipping of the ring onto a rod of a reservoir being arranged in cross direction preferably directly laterally of the gripper unit. For example it may be effected, by opening the gripper units slightly offset in time, e.g. 1 sec., the ring to turn out of the xz-plane and then to autonomously fall out of the further gripper unit being opened. In particular, the process then may be continued directly at step S1 in case a gripper unit being arranged in the bonding position also already allows for gripping of a new section, be it by the same gripper unit, be it by a further gripper unit.

According to a variant the device comprises more than two gripper units which are arranged such that, when a pair of grippers is arranged in the bonding position, then at least one further gripper unit is arranged already also in the null position or at least approximately in the null position. Thus, a displacing back or rotating back does not necessarily have to be carried out. Rather, the pair of grippers being arranged in the bonding position may slightly be rotated further on, e.g. by 20°, in order to create a clearance for the string to be fed and in order to arrange a further pair of grippers in the null position. This may also save time and may allow for great lot sizes. For example several gripper units can be arranged circumferentially respectively on a disk. Optionally the respective gripper unit can be swivel-mounted.

In a sixth step S6 a moving of a gripper unit resp. the displacing back of the respective gripper unit towards the null position can be carried out, especially of both gripper units synchronously, especially with opposing senses of rotation. The sixth step may comprise an ejection, especially before moving the gripper unit. Thereby, the sixth step S6 can comprise a point of control in which is controlled an ejection, especially with respect to the manner or moment of freeing the sealing ring by the gripper unit(s), and/or in which the manner resp. the moment and/or the speed of the motion are controlled. At the end of the sixth step S6 the gripper unit/s 40a, 40b is/are thus arranged in the null position again and are configured for gripping a newly fed string-section.

FIG. 8 respectively also indicated direct arrows between the individual steps, bypassing the points of control, whereby should be emphasized on the fact that individual points of control may also be skipped, depending on whether the device can/should be pre-adjusted in this regard, or whether the servo loop should be applied only randomly.

Referring to FIGS. 1 to 8, a specific embodiment of the method is described in the following, namely one of the potential variants for automatized cutting to length and agglutinating of (cellular) rubber profiles provided as material sold by the meter for providing rings.

The material sold by the meter (round cord) 1, which has to be agglutinated, is stored at the start side of the device 10, especially wound up on a spool package. Thereupon, by means of a feeder unit 20, especially a feeder with four rolls and with pivot encoder (measuring of pivot angle) for linear measurement, the round cord 1 is transferred to one of two gripper units 40a, 40b mounted on gear wheels 70a, 70b. During running-in resp. during feeding of the cord 1, both gripper units are opened. Thereby the gripper units can be provided especially in the form of bipolar lifting magnets with end position fixation. As soon as the cord 1 has reached a specific null position resp. an end switch, the second gripper unit 40b (being arranged in greater distance to the feeder) is closed, whereby the cord 1 is fixed thereto. The cord 1 is fed forward further by the feeder unit 20 as far as to the desired target-length resp. as far as corresponding to the desired diameter of the ring to be produced, namely as far as to a region between the gripper units. Thereby the corresponding section 1.2 of the cord is hold in the shape of a loop. As soon as the target-length is reached, the first gripper unit 40a is closed, whereby the corresponding end of profile 1a of the cord is also fixed. Thereupon a cutting unit 30 being installed between the feeder and the first gripper unit cuts the cord to the desired, pre-programmable resp. adjustable length.

Thereupon, a drive unit 80 being connected to a control device 50, especially a step motor can rotate the two gear wheels 70a, 70b, especially by 90 degrees, in a wetting position Pf. As soon as the desired situation of both gear wheels is reached, a deposition of bonding fluid F resp. adhesive is carried out, namely by means of a feeding unit 61 resp. by means of a dosing pump, which feeding unit is arranged preferably above the wetting position. Dripping of bonding fluid can be prevented by slight backturn of the dosing pump resp. of a corresponding step motor, especially after the gluing process. For example, the step motor can be actuated ten steps forwards (corresponding to a specific quantity x ml of adhesive output), and thereupon two steps backwards, corresponding to a slight retraction of the adhesive out of the outlet resp. out of a deposition needle.

Vapors emitted during bonding, especially adhesive vapors containing cyanite, may thereby be extracted by suction. In contrast to manual agglutination, these vapors thus do not implicate health hazards, or may at least be evacuated before a human being may inhale these vapors. Extraction by suction may especially be carried out via at least one activated carbon filter.

After having deposited the bonding fluid, the step motor 80 turns the respective gripper unit further as far as to the bonding position resp. pressing position Pp. In the bonding position both ends of profile 1a, 1b of the cord are docked to one another, especially frontally. This arrangement resp. the pressing position Pp is retained for a predefinable minimum time, especially in dependence of the type of used bonding fluid or of the bonded material, for example 5 seconds. As soon as the minimum time has passed, the gripper units are opened again. The produced/bonded ring 1.3 now can be extracted out of the device 10 resp. can be ejected by means of an ejector (not shown). The ejector may evoke ejection in pneumatic manner (air blast), especially by arranging the ejector behind the gripper units resp. behind the respective feedthrough resp. behind the bonding position.

For preparing the subsequent bonding process the step motor 80 may place back again the gear wheels 70 in the initial position resp. null position, especially by turning them back. In this connection the gripper units may remain opened. As soon as the initial position is reached, the material sold by the meter again can be transported to the second gripper unit 40b by means of the feeder unit, and the process described above can be repeated until a desired/preset lot size of rings 1.3 has been reached.

With the aid of the control device 50, at least the following criteria or parameters can be defined, especially at the beginning of a respective bonding/gluing process:

desired lot size of rings;

length of the desired profile section resp. diameter of the ring;

duration of the bonding process resp. of the adhesive sealing, depending on the kind of used bonding fluid/glue and environmental conditions.

As a summary, the following can be mentioned: In many situations, some process steps for the production of sealing rings made of elastic flexible, especially elastomer material have to be carried out manually, especially a conglutination of free ends of a cut section of endless-material. The present invention provides a device and a method whereby not only the bonding, especially the positive substance jointing of the free ends can be automatized, but also a cutting to a desired length, or an ejection. Hereby, great lot sizes of sealing rings can be produced in flexible and predefined manner and in an automatized and cost-effective manner.

The present invention is not limited to embodiments described herein; reference should be had to the appended claims.

What is claimed is:

1-15. (canceled)

16. A device for producing sealing rings made of an endless-material, the device comprising:
a feeder unit configured to convey and position the endless-material in at least one cutting position;
a cutting unit configured to cut off a section of the endless-material;
at least one gripper unit configured to grip and to displace the endless-material or the section of the endless-material and to control a displacement of at least one free end of the section of the endless-material along a predefined path of motion in and/or out of a wetting position;
a control device connected with at least one of the feeder unit, the at least one gripper unit, and the cutting unit; and
a feeding device for a bonding fluid, the feeding device being connected with the control device and being arranged so that the bonding fluid is deposited in a controlled manner on the at least one free end of the section of the endless material in the wetting position.

17. The device as recited in claim 16, wherein,
two free ends of the section of the endless-material are docked to one another, and
the at least one free end of the section of the endless material or the at least one gripper unit is displaceable in a bonding position in which the two free ends of the section are docked to one another.

18. The device as recited in claim 16, wherein,
at least one gripper unit comprises a first gripper unit and a second gripper unit,
the at least one free end of the section of the endless-material is displaceable in a bonding position which is arranged between the first gripper unit and the second gripper unit, and
the first gripper unit and the second gripper unit each being arranged in a null position during the cutting off.

19. The device as recited in claim 18, wherein,
the feeding device for the bonding fluid comprises at least one feeding unit which is configured to feed the bonding fluid, and
the at least one feeding unit is positioned or aligned with respect to a path of motion of the section of the endless-material or of the first gripper unit and the second gripper unit.

20. The device as recited in claim 19, wherein the at least one feeding unit is further configured to guide the endless-material to the first gripper unit and along and past the first gripper unit to the second gripper unit.

21. The device as recited in claim 16, further comprising:
a land contour or a guiding contour or a slide contour which is arranged so that the endless-material or the section of the endless material is guided away from the cutting unit and along the predefined path of motion or along a predefined contour.

22. The device as recited in claim 16, further comprising:
a pivotable motor-driven disk,
wherein,
the at least one gripper unit is aligned in an eccentric position on the pivotable motor-driven disk.

23. The device as recited in claim 16, wherein the predefined path of motion of the at least one free end of the section of the endless material is a circular path at least in sections.

24. The device as recited in claim 16, further comprising:
a drive unit; and
at least one disk which is arrangeable in a predefined pivot position via the drive unit,
wherein,
the at least one gripper unit is arranged eccentrically on the at least one disk.

25. The device as recited in claim 16, wherein,
the at least one gripper unit comprises a first gripper unit and a second gripper unit, and
the device is configured,
to displace two respective free ends of the section of the endless material via the first gripper unit and the second gripper unit, respectively, along the respective predefined path of motion of the two respective free ends of the section of the endless material in the wetting position so that the two respective free ends of the section of the endless material are positioned for a deposition of the bonding fluid, and then
to dock to one another the free ends of the two respective free ends of the section of the endless material in a bonding position.

26. A control device configured to actuate the device as recited in claim 16, the control device comprising:
a memory in which is stored at least one of,
position data of a null position of the at least one gripper unit,
position data of at least one wetting position,
position data of a bonding position,
data relating to a path of motion of the at least one gripper unit, and
data on characteristics of at least one type of the endless-material; and
a communication interface configured to connect to at least one of the feeder unit, the cutting unit, the at least one gripper unit, and the feeding device.

27. A method of using the at least one disk in the device as recited in claim 24 to produce the sealing rings made of the endless-material, the method comprising:
providing the at least one disk in the device as recited in claim 24; and
using the at least one disk to position at least one component selected from,
the at least one gripper unit for gripping the endless-material,
the endless-material in the wetting position for depositing the bonding fluid on at least one free end of the section of the endless-material, and
the endless-material in the bonding position for bonding two free ends of the section of the endless material.

28. A method of producing the sealing rings made of the endless-material as recited in claim 16, the method comprising:
feeding and positioning the endless-material in at least one cutting position;
cutting off a section of the endless-material in the at least one cutting position;
gripping and displacing of the section of the endless-material cut off via the at least one gripper unit, the displacing of the section of the endless material being carried out after the cutting off step and comprising a controlled displacement of at least one free end of the section along a predefined path of motion in a wetting position or out of the wetting position; and
depositing a bonding fluid onto the at least one free end which is positioned in the wetting position.

29. The method as recited in claim 28, wherein,
the at least one gripper unit comprises two gripper units, and
the at least one free end comprises two free ends, and
after the depositing of the bonding fluid, the method further comprises:
displacing of at least one of the free ends of the section; or
displacing both free ends of the section out of the wetting position in the bonding position between two null positions in which is respectively arranged one of the two gripper units during the cutting.

30. The method as recited in claim 28, wherein,
the free ends of the section comprise a respective face side, and
the method further comprises:
displacing the respective face side of each of the free ends from an out of an alignment averted from each other position to an in alignment frontally facing each other position in the bonding position.

31. The method as recited in claim 28, wherein, after the depositing of the bonding fluid onto the at least one free end which is positioned in the wetting position, the method further comprises:
retracting the at least one gripper unit out of the bonding position in a null position on a circular path.

32. The method as recited in claim 28, wherein, during the displacing of the section of the endless-material cut off via the at least one gripper unit, the at least one gripper unit is guided along a circular path with a changing sense of rotation.

33. The method as recited in claim 32, wherein the at least one gripper unit is guided by a disk.

34. The method as recited in claim 28, wherein,
during the displacing of the section of the endless-material cut off via the at least one gripper unit, two gripper units are guided on respective circular paths with respective changing senses of rotation, and
two disks which engage each other are rotated.

35. The method as recited in claim 28, further comprising:
moving the at least one gripper unit between three pivot positions,
wherein,
one of the three pivot positions corresponds to a null position for gripping the section,
one of the three pivot positions corresponds to the wetting position,
one of the three pivot positions corresponds to the bonding position, and
the three pivot positions are offset by 90° with respect to each other.

36. A sealing ring made of an endless-material, the sealing ring being produced by a method comprising:
a controlled gripping of a cut section of the endless-material;
displacing at least one free end of the cut section on a circular path along a predefined path of motion in a wetting position; and
depositing of a bonding fluid on the at least one free end arranged in the wetting position.

37. A sealing ring made of an endless-material, the sealing ring being produced via the method as recited in claim 28.
